(19) United States
(12) Patent Application Publication
(10) Pub. No.: US 2008/0207824 A1
(43) Pub. Date: Aug. 28, 2008

(54) Method for Dispersing Carbon Nanotubes in a Polymer Matrix

(75) Inventors: Michael Alexandre, Ougree (BE); Daniel Bonduel, Mons (BE); Michael Claes, Liege (BE); Dubois Philippe, Ciplet (BE); Sophie Peeterbroeck, Virginal (BE); Sven Pegel, Dresden (DE); Petra Potschke, Dresden (DE)

Correspondence Address: REINHART BOERNER VAN DEUREN P.C., 2215 PERRYGREEN WAY, ROCKFORD, IL, 61107, US

(73) Assignee: Nanocyl S.A, Sambreville (BE)

(21) Appl. No.: 11/915,500

(22) PCT Filed: May 24, 2006
(86) PCT No.: PCT/BE06/00061

§ 371 Date: Nov. 26, 2007

Related U.S. Application Data
(60) Provisional application No. 60/783,784, filed on Mar. 17, 2006.

(30) Foreign Application Priority Data
May 30, 2005 (EP) 05447125.5

(51) Int. Cl. C08K 3/04

(52) U.S. Cl. 524/546; 524/584; 524/563; 524/570; 524/606; 524/612; 524/592; 524/577; 524/609; 524/568; 524/553; 524/599

(57) ABSTRACT

The invention concerns a method for dispersing carbon nanotubes in a polymer matrix including a step of preparing carbon nanotubes coated with a polymer coating by a method for polymerizing a monomer using a catalytic system wherein carbon nanotubes are used as catalytic support, the carbon nanotubes comprising in surface the catalytic system for polymerizing the coating polymer, and the coating polymer being non-miscible in the host polymer matrix, followed by a step of hot process mixing of the coated carbon nanotubes with a polymer matrix.

### FIELD OF THE INVENTION

The present invention relates to the field of composite materials, and more particularly to nanocomposites. The invention relates to an improved method for dispersing carbon nanotubes in a polymer matrix.

### STATE OF THE ART

Among polymer matrix composites, distinction may be made, according to the size of the particles, between “microcomposites” where the three dimensions of the charge are greater than or equal to a micrometre, and “nanocomposites” in which at least one of the three dimensions of the charge is less than 100 nm, or even of the order of one to a few tens of nanometres.

Nanocomposites are of particular interest in the industrial sphere since they have remarkable properties for relatively low charge rates, i.e. less than 10% by weight. In fact, they significantly improve the mechanical or electrical properties of the polymer matrix. In addition, unlike reinforcement of a fibrillar type, they reinforce the polymer matrix in all spatial directions.

Nanocomposites comprising carbon nanotubes as particle charges have already been proposed for various applications.

However, in practice, the use of carbon nanotubes as charges in polymer matrices in order to create nanocomposites runs into problems. In fact, it turns out that carbon nanotubes tend to aggregate together to form very stable “bundles”, also known as aggregates or agglomerates. The presence of such aggregates adversely affects the physical and mechanical properties of the composites in which they are present.

In order to avoid this aggregation phenomenon and to preserve the physical, mechanical and electrical properties of the polymer matrices forming such composites, coating the carbon nanotubes was thought of. Thus, document WO 02/16257 discloses a composition comprising single-wall carbon nanotubes coated in a polymer. Mention may also be made of document WO 2005/040265 that discloses a composition comprising a polymer matrix and 0.1 to 10% by weight of nanotubes coated in polyaniline.

However, these solutions allow to limit the size of aggregates without entirely preventing their formation, in order to obtain homogeneous dispersion on a nanoscopic scale.

In addition, document WO 2005/012170 discloses a particular coating method that allows to increase the compatibility of carbon nanotubes with the polymer matrix in which they are to be dispersed. This allows to obtain a homogeneous and stable dispersion of the carbon nanotubes in a polymer matrix. This method is characterised by the fact that the carbon nanotubes are used as catalytic supports due to the settling at their surfaces of a co-catalyst/catalyst couple, in order to form a catalytic system. The catalytic system is activated before polymerisation occurs on the surface of the carbon nanotubes in order to create a coating around these carbon nanotubes.

However, the coating polymer used in the above-described method uses a coating polymer that is miscible with the polymer matrix of the composite. Now, according to the present invention, it is not necessary, and may even prove counterproductive, to use miscible polymers for the matrix and the coating.

### Aims of the Invention

The present invention aims to provide a solution that does not have the drawbacks of the state of the art.

In particular, the present invention aims to provide an improved method for the dispersion of carbon nanotubes in a polymer matrix that is either non-miscible compatible, or non-miscible incompatible with the polymer for coating the carbon nanotubes.

The present invention also aims to provide the use of the improved method of dispersion in order to obtain a nanocomposite in which the carbon nanotubes are homogeneously dispersed in a polymer matrix on a nanoscopic scale.

### SUMMARY OF THE INVENTION

The present invention relates to a method for dispersing carbon nanotubes within a host polymer matrix comprising the following steps:
preparation of carbon nanotubes coated in a coating polymer by a polymerisation method of a monomer by means of a catalytic system in which said carbon nanotubes are used as catalytic supports, said carbon nanotubes comprising at their surfaces said catalytic system for the polymerisation of said coating polymer, said coating polymer being non-miscible with said host polymer matrix,
mixing of said coated carbon nanotubes with said non-miscible host polymer matrix, said coating polymer acting as a transporter for the carbon nanotubes in said host polymer matrix.

By “host polymer matrix” is meant a polymer which forms the matrix of a composite in which particles, also called charges, are dispersed.

Two polymers are said to be non-miscible compatible or incompatible when, on various measurement scales, a phase-separation effect is observed. This phase separation may be observed on the micrometre scale by viewing the mixture with a scanning electron microscope, which often shows nodules of the minority polymer in the majority polymer. On a quasi-molecular scale, the non-miscibility of two polymers can be observed by the presence of two vitreous transition temperatures that are characteristic of the two polymers making up the mixture. These vitreous transitions may be measured by various techniques such as differential scanning calorimetry or dynamic mechanical analysis.

Two polymers are said to be non-miscible when the free energy of the mixture (ΔGₘᵢₓ) is greater than or equal to zero.

Two polymers are said to be non-miscible incompatible when the free energy of the mixture is greater than or equal to zero, when no modification of the respective vitreous transition temperatures (Tg) of the partners can be observed, when the mixture has a Flory-Huggins parameter χ (chi) greater than zero, and when the interface tension is high. The interface tension, which is proportional to the square of the Flory-Huggins parameter χ (chi), is considered “high” when it is greater than 2 mN/m.

Two polymers are said to be non-miscible compatible when the free energy of the mixture is greater than or equal to zero, when modifications of the respective vitreous transition temperatures (Tg) of the partners can be observed, when the mixture has a Flory-Huggings parameter χ (chi) that is low but greater than zero, and when the interface tension is low, i.e. between 0 and 2 mN/m. The interface tension, which is proportional to the square of the Flory-Huggings parameter χ (chi) is considered “low” when it is between 0 and 2 mN/m.

For a polyethylene/EVA mixture, the interface tension is considered low when it is of the order of 2 mN/m and, as regards a polyethylene/polyamide or polyethylene/polycarbonate mixture, it is considered low when it is greater than 2 mN/m.

According to particular embodiments, the invention has one or several of the following features:
the non-miscible compatible polymer matrix is a polymer forming two phases with said coating polymer during mixing and having a free energy of the mixture (ΔGₘᵢₓ) greater than zero;
the non-miscible compatible host polymer matrix is selected from the group consisting of polypropylene, ethylene vinyl acetate copolymer (EVA), alpha-olefin copolymers and mixtures thereof;
the host polymer matrix is a non-miscible incompatible polymer forming two phases with said coating polymer and having a chemical structure different to that of said coating polymer, the mixture of said coating polymer and of the host polymer matrix having a Flory-Huggins parameter χ (chi) greater than zero and a high interface tension;
the incompatible non-miscible host matrix polymer is selected from the group consisting of polyamide (PA), polycarbonate (PC), polyether ether ketone (PEEK), polyether ketone (PEK), polystyrene, polyoxymethylene (POM), polyethyleneimine (PEI), polysulphone (PSU), polyacetale, polyetherimide, polyimide, polysulfene, polyacrylonitrile, polyphenylene sulfide, polyphenylene oxyde, polyurethane, polytetrafluoroethylene, polyester, polyvinylidene fluoride, polyvinylchloride, polyethersulfide, poly perfluoroaldoxyethylene and mixtures thereof;
the coating polymer is selected from the group consisting of polyethylene, polypropylene, copolymers with alpha-olefins, conjugated alpha-diolefin polymers, polystyrene, polycycloalkenes, polynorbornene, polynorbornadiene, polycyclopendadiene and mixtures thereof;
the coating polymer is an alpha-olefin polymer;
the coating polymer is polyethylene;
the coating polymer for the carbon nanotubes represents between 10 and 90% by weight of the total weight of the coated nanotubes;
the quantity of carbon nanotubes represents between 0.1 and 5% by weight of the total weight of the host polymer matrix;
the quantity of carbon nanotubes represents between 0.1 and 1% by weight of the total weight of the host polymer matrix;
the carbon nanotubes are multi-wall carbon nanotubes (MWNTs).

The present invention also discloses the use of a polymer for coating carbon nanotubes, that is non-miscible compatible or incompatible with a host polymer matrix, in order to obtain homogeneous dispersion of said carbon nanotubes within a host polymer matrix on a nanoscopic scale.

By homogeneous dispersion of the carbon nanotubes “on a nanoscopic scale” is meant the homogeneous distribution of the carbon nanotubes on a scale of billionths of a metre. Carbon nanotubes are, on that scale, essentially separated from each other and practically form no agglomerates or aggregates.

By “nanocomposites” is meant composite materials having a polymer matrix and incorporating nanoparticles as a charge, that is particles of which at least one of the dimensions is less than or equal to 100 nm. It may also be the case that at least one of the dimensions of the particles is of the order of one to a few tens of billionths of a metre.

### BRIEF DESCRIPTION OF THE FIGURES

FIG. 1 shows the different steps for preparing the coated carbon nanotubes with, as steps (i) and (ii), settling of the co-catalyst (MAO) and evaporation of the solvent (toluene), (iii) settling of the n-heptane catalyst, Cp₂ZrCl₂, (iv) and (v) polymerisation of the ethylene at 2.7 bar and 50° C. in order to create a high-density polyethylene coating.

FIG. 2A shows purified multi-wall carbon nanotubes (MWNTs), viewed with a scanning electron microscope.

FIG. 2B shows multi-wall carbon nanotubes coated in 51% by weight of high-density polyethylene, viewed with a scanning electron microscope.

FIG. 2C shows multi-wall carbon nanotubes coated in 83% by weight of high-density polyethylene, viewed with a scanning electronic microscope.

FIG. 3A shows uncoated multi-wall carbon nanotubes, viewed with a transmission electron microscope (TEM), as dispersed in an ethylene vinyl acetate copolymer matrix with 28% by weight of vinyl acetate (EVA 28). Aggregates of carbon nanotubes are observed.

FIG. 3B shows the same sample as viewed by an atomic force microscope (AFM) Aggregates of carbon nanotubes are also observed.

FIGS. 4A (TEM) and 4B (AFM) show multi-wall carbon nanotubes coated in high-density polyethylene and homogeneously dispersed on a nanoscopic scale in a 28% vinyl acetate EVA matrix.

FIG. 5 shows measurements of electrical resistivity depending on the level of charge of carbon in different nanocomposites with a polycarbonate matrix.

FIG. 6 shows measurements of electrical resistivity depending on the percentage of carbon nanotubes contained in nanocomposites with a polycarbonate matrix.

FIG. 7 shows an electron microscope image of a nanocomposite with a polycarbonate matrix comprising 0.25% by weight of carbon nanotubes that have been coated in a polyethylene polymer, the coating polymer being 78% by weight of the total weight of the coated carbon nanotubes.

FIG. 8 shows an electron microscope image of a nanocomposite with a polycarbonate matrix comprising 0.25% by weight of carbon nanotubes that have been coated in a polyethylene polymer, the coating polymer being 56% by weight of the total weight of coated carbon nanotubes.

FIG. 9 shows measurements of electrical resistivity depending on the percentage of charge of various nanocomposites.

FIG. 10 shows an electron microscope image of a nanocomposite with a polyamide matrix comprising 1% by weight of carbon nanotubes that have been coated in a polyethylene polymer, the coating polymer being 75% by weight of the total weight of the coated carbon nanotubes.

FIG. 11 shows an electron microscope image of a nanocomposite with a polyamide matrix comprising 5% by weight of carbon nanotubes that have been coated in a polyethylene polymer, the coating polymer being 75% by weight of the total weight of the coated carbon nanotubes.

FIGS. 12 and 13 show the influence of the quantity of carbon nanotubes, dispersed by means of the method as in the invention or dispersed in the usual way, on the viscosity of a polypropylene or polycarbonate matrix.

FIGS. 14 and 15 show the influence of the quantity of carbon nanotubes, dispersed by means of the method as in the invention or dispersed in the usual way, on the tensile modulus of a polycarbonate or polyamide matrix.

FIGS. 16 and 17 show the influence of the quantity of carbon nanotubes, dispersed by means of the method as in the invention or dispersed in the usual way, on the deformation and elongation at break characteristics of a polycarbonate or polyamide matrix.

FIGS. 18 and 19 show the influence of the quantity of carbon nanotubes, dispersed by means of the method as in the invention or dispersed in the usual way, on the characteristics of break resistance of a polycarbonate or polyamide matrix.

FIGS. 20 and 21 show the influence of the quantity of carbon nanotubes, dispersed by means of the method as in the invention or dispersed in the usual way, on the characteristics of impact resistance of a polycarbonate or polyamide matrix.

### DETAILED DESCRIPTION OF THE INVENTION

The use of a coating in order to obtain carbon nanotubes in a dispersed state within a polymer matrix is well known.

The originality of the present invention is based on the use of a polymer for coating carbon nanotubes, that is non-miscible compatible or incompatible with the polymer matrix. Surprisingly, this allows to obtain a homogeneous dispersion of carbon nanotubes within said polymer matrix on a nanoscopic scale. Moreover, this allows to improve the electrical characteristics of nanocomposites comprising carbon nanotubes dispersed as in the invention whilst at the same time preserving the mechanical properties of the polymer matrix forming these nanocomposites.

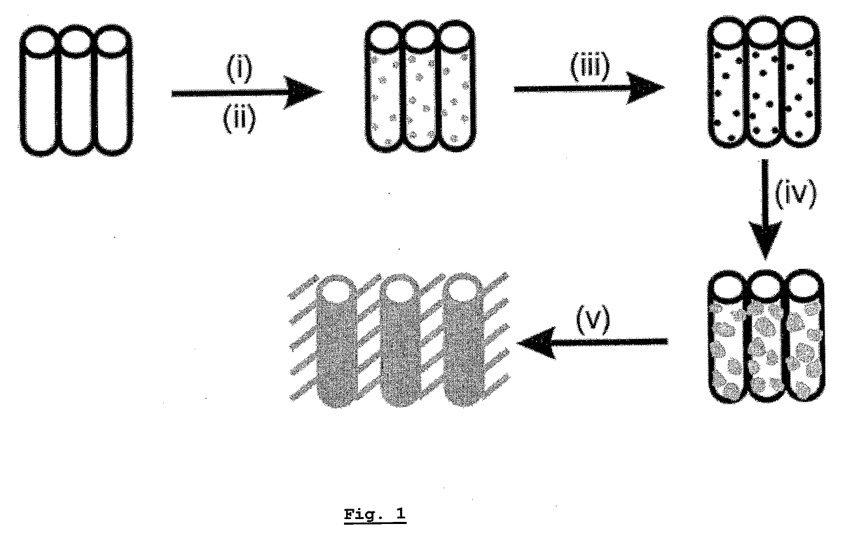

The method for coating carbon nanotubes using the dispersion method as in the invention may be that known by the name of the “Polymerisation Filling Technique” or “PFT” (FIG. 1) and described in detail in document WO 2005/012170, which is incorporated by reference into the present text.

The coating used in the present invention may be that claimed in claim 1 of document WO 2005/012170.

The carbon nanotubes are preferably pre-treated in the way described in claim 2 as well as in paragraphs 97 and 98 and paragraphs 116 to 125 of document WO 2005/012170. The pre-treatment consists in settling a catalyst, known to catalyse the polymerisation of the monomer used for the coating, to the surface of the carbon nanotubes, the polymerisation is subsequently started directly on the surface of the nanotubes.

The catalyst and the catalyst/co-catalyst couple are preferably selected according to claims 6 to 9 of document WO 2005/012170 and advantageously according to the examples given in paragraphs 104 to 106, and the polymerisation of the coating polymer may be achieved according to the method described in paragraphs 126 to 130 of document WO 2005/012170.

The polymerisation, achieved at the surface of the nanotubes in order to obtain a coating polymer, allows the dissolution of bundles, agglomerates or aggregates of nanotubes that usually form during the production of nanocomposites comprising carbon nanotubes. This coating has the effect of forcing the carbon nanotubes to separate from each other and thereby causing the dissolution of nanotube bundles.

Once they are coated, even with a small quantity of polymer, the carbon nanotubes can then be dispersed in a host polymer that is commercially available by traditional methods (internal blender, extruder, etc.). The dispersion obtained is homogeneous on a nanoscopic scale.

Surprisingly, and as shown in FIG. 5, a nanocomposite with a polycarbonate matrix, whose carbon nanotubes coated with polyethylene have been dispersed by the means of the method as in the invention (N9000, FIG. 5), has lower electrical resistivity and therefore better electrical conductivity than a nanocomposite whose carbon nanotubes have not been coated (N7000, FIG. 5) and than compositions with other types of carbon charges (Cabot Vulcan, Akzo Ketjen, Hyperion Fibrils).

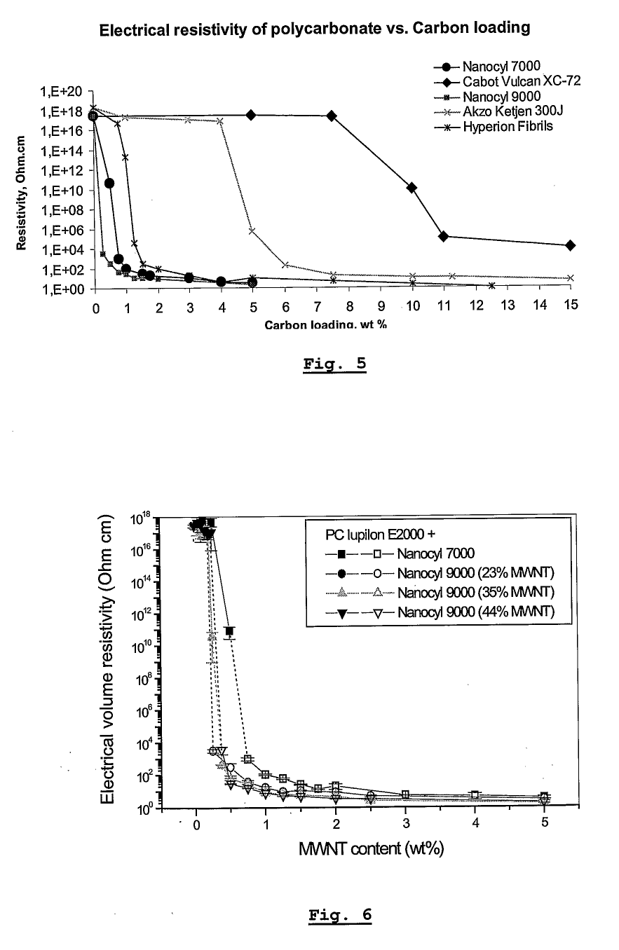

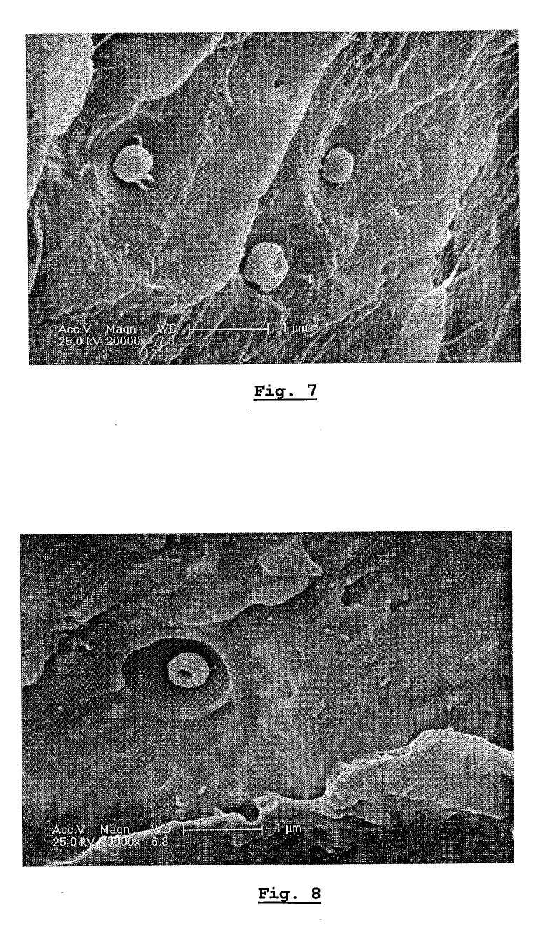

Moreover, nanocomposites comprising carbon nanotubes dispersed by means of the method as in the invention have electrical conductivity equivalent to the composites described in the state of the art, but this electrical conductivity is however obtained with a quantity of carbon nanotubes well below that required in the case of the nanocomposites of the state of the art. In fact, whereas 1% by weight of carbon nanotubes (MWNT N700, FIG. 6) was required to obtain a given electrical resistivity, it now requires no more than 0.25% by weight to obtain the same level of electrical resistivity (FIG. 6). Therefore, in nanocomposites comprising carbon nanotubes dispersed by means of the method as in the invention, the percolation network is established with a much lower percentage of carbon nanotubes. The use of a low proportion of carbon nanotubes turns out to be very interesting since this allows not only to reduce the manufacturing cost of such nanocomposites but also to improve the electrical properties whilst preserving the mechanical properties of the polymer matrix.

This surprising improvement in the properties of electrical conductivity, observed for a nanocomposite whose carbon nanotubes have been dispersed by means of the method as in the invention, lies in the use for coating of a polymer that is non-miscible compatible or incompatible with the polymer matrix of the composite. This non-miscibility or incompatibility between the coating polymer and the polymer matrix will allow the coating to play the part of a “transporter of carbon nanotubes” and thereby bring about homogeneous dispersion. The coating, and more particularly the polymerisation of the coating polymer achieved at the surface of the nanotubes, will allow each carbon nanotube to be kept separate. Then, during the incorporation of these carbon nanotubes into the polymer matrix, the coating, due to its non-miscibility (compatible or incompatible) and due to the fact that it does not have a covalent bond with the carbon nanotubes, will be literally “chased” off the surface of the carbon nanotubes. Therefore, as shown in FIGS. 7 & 8 and also in FIGS. 10 & 11, the carbon nanotubes are left without coating but are nevertheless perfectly dispersed within the polymer matrix whereas the polyethylene, having acted as coating, is found in the form of droplets. As shown in FIG. 7, these droplets of polyethylene may also contain coated carbon nanotubes but their proportion is minute compared with the total quantity of carbon nanotubes in the nanocomposite.

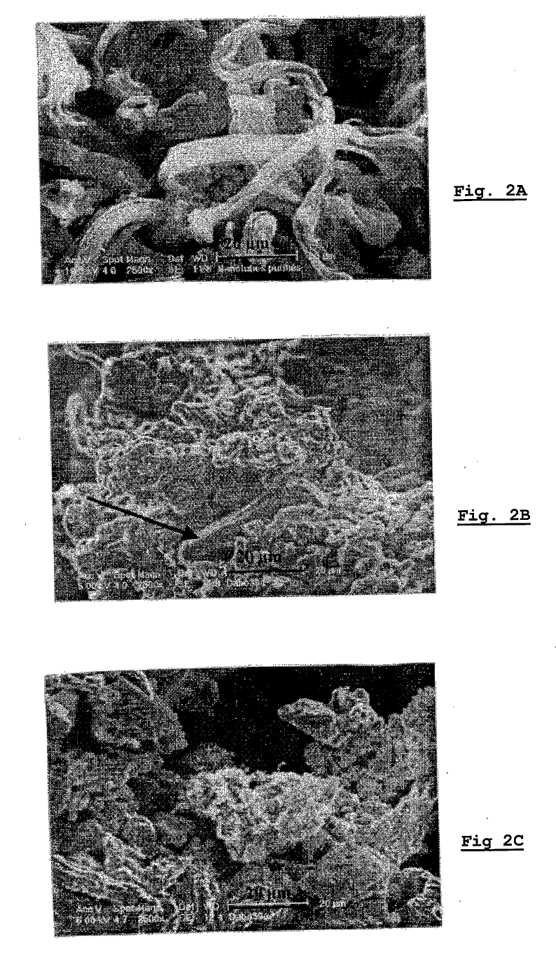

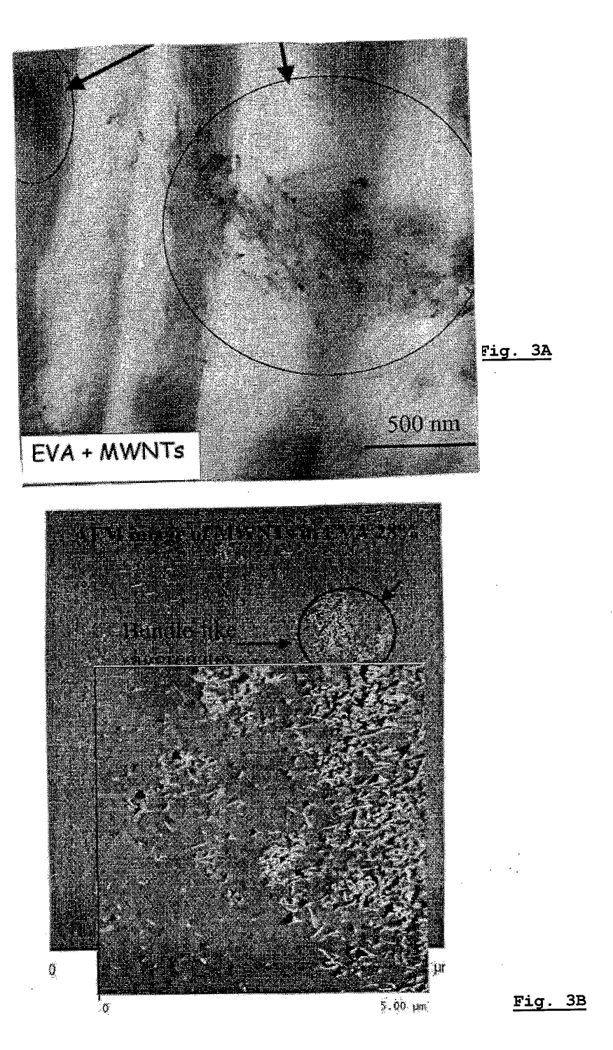

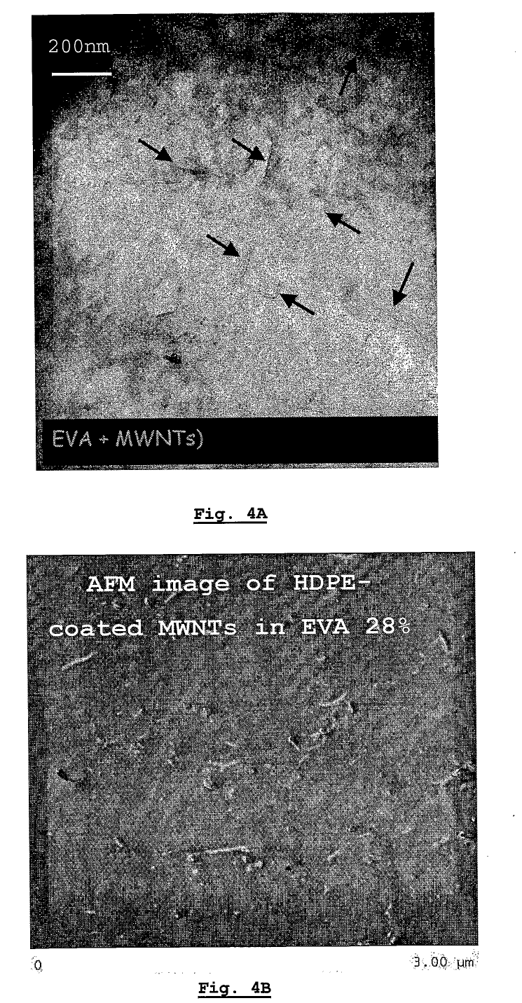

In a first embodiment example of the invention, the multi-wall carbon nanotubes (MWNTs) are coated in high-density polyethylene (HDPE) (FIGS. 2B & 2C) and incorporated into a polymer matrix which is an ethylene vinyl acetate (EVA) copolymer with a high proportion of vinyl acetate (28% by weight) (FIGS. 4A & 4B).

The non-miscibility and compatibility of the HDPE and the EVA at room temperature hav been the subject of numerous studies and is documented in particular in the “Polymer Handbook” 4^{th} edition, Ed. J. Wiley and Sons, New York, 1999, by J. Bandrup, E. H. Immergut and E. A. Grulke.

The non-miscibility between EVA and HDPE is documented in detail in the following three publications:
“Dynamic mechanical properties and morphology of polyethylene/ethylene vinyl acetate copolymer blends”, Khonakdar, Wagenknecht, Jafari, Hässler and Eslami in Advances in Polymer Technology, Vol. 23, No. 4, 307-315;
“Phase morphology and melt viscoelastic properties in blends of ethylene/vinyl acetate copolymer and metallocene-catalysed linear polyethylene”, Péon, Vega, Del Amo, and Martinez in Polymer 44 (2003) 2911-2918;
“Dynamic mechanical behaviour of high-density polyethylene/ethylene vinyl acetate copolymer blends: The effect of the blend ratio, reactive compatibilization and dynamic vulcanization”, Biju, Varughese, Oommen, Pötschke and Thomas in Journal of Applied Polymer Science, Vol. 87, 2083-2099 (2003).

In addition, the use of the HDPE and EVA (28% VA) couple allowed to perform tests on the dispersion of nanotubes coated in HDPE in the EVA matrix at different temperatures, allowing the two polymers either to stand both in the molten state, or for the HDPE to remain in a solid state and for the EVA matrix to be in a molten state. The difference in the melting temperatures between the coating HDPE and the EVA matrix (28% VA) being about 40° C.

The dispersion tests at two different temperatures nevertheless gave the same result in terms of the carbon nanotube dispersion on a nanoscopic scale (FIG. 4B). Surprisingly, it is noted that the dispersion also occurs on a nanoscopic scale in an EVA matrix with a high level of vinyl acetate whereas one would have expected, in view of the non-miscibility of the two polymers, to find nanotube aggregates resulting from the coalescence of the HDPE coatings, which is not the case.

For composites based on EVA (28% by weight of vinyl acetate), the mechanical properties are compared with those of a nanocomposite based on clay (Cl 30B): montmorillonite organomodified by methyl bis (2-hydroxyethyl) ammonium tallow) of an exfoliated type (nanosheets of clay homogeneously dispersed in a nanoscopic state)—see Table I.

TABLE I

| | Young Modulus (MPa) |
|---|---|
| EVA alone | 11.9 |
| EVA + 1% by weight of Cl. 30B | 16.0 |
| EVA + 3% by weight of Cl. 30B | 22.8 |
| EVA + 1% by weight of MWNT | 15.8 |
| EVA + 3% by weight of MWNT | 20.0 |
| EVA + 3% by weight of MWNT* | 29.0 |
| EVA + 3% by wt Cl. 30B/% by wt MWNT | 26.0 |
| EVA + 3% by wt Cl. 30B/% by wt MWNT* | 35.4 |

*HDPE (45% by weight) - MWNTs coated via PFT MWNT = multi-wall nanotube(s)

These results show the transfer to the EVA matrix of the properties of the carbon nanotubes, that have been coated in HDPE. Compared with nanocomposites based on clay, carbon nanotubes that have been coated show an increase in the Young modulus, which indicates an excellent transfer to the EVA matrix of the rigidity properties of the carbon nanotubes.

In a second embodiment example of the invention, the multi-wall carbon nanotubes (MWNTs) are coated in a polyethylene polymer and incorporated into a polycarbonate matrix (Iupilon E 2000, Mitsubishi Plastics, Japan).

The polycarbonate and the multi-wall carbon nanotubes are premixed in the form of powder, the polycarbonate being dried at 120° C. for at least 4 hours, before being mixed under heat (280° C.) with a DACA Micro Compounder blender for 15 minutes at 50 revolutions per minute. The plates obtained after pressing at 280° C. have a thickness of 0.35 mm and a diameter greater than 65 mm.

Surprisingly, and as shown in FIG. 6 in the form of a graph, for a nanocomposite with a polycarbonate matrix, the percolation network forms with 0.25% by weight of carbon nanotubes that have been coated, the high-density polyethylene (HDPE) coating being 78% or 65% by weight of the total weight of the coated nanotubes. For carbon nanotubes whose HDPE coating is 56% by weight of the total weight of the coated nanotubes, percolation is obtained with a percentage of carbon nanotubes of 0.375%, whereas for uncoated nanotubes (N700, FIG. 5), the percolation threshold is 0.75%.

Thus, the quantity of polymer for coating the nanotubes affects the dispersion quality of the carbon nanotubes within the matrix and as a result, affects the electrical conductivity characteristics of the nanocomposite; in fact, for a composite with a polycarbonate matrix comprising 0.25% by weight of MWNTs that are coated then dispersed by means of the method as in the invention, the use of a polyethylene coating, being 78% by weight of the total weight of the coated carbon nanotubes, allows to obtain a nanocomposite with better electrical conductivity than a nanocomposite in which the coating is only 56% by weight of the total weight of the coated carbon nanotubes.

As the electron microscope images (FIGS. 7 & 8) show, a nanocomposite that comprises a polycarbonate matrix and 0.25% by weight of MWNTs coated in polyethylene and dispersed by means of the method as in the invention has a fine and homogeneous dispersion of the carbon nanotubes in the polymer matrix on a nanoscopic scale.

In a third embodiment example of the invention, multi-wall carbon nanotubes (MWNTs) are coated with high-density polyethylene and dispersed by means of the method as in the invention in a polyamide matrix (Capron 8202).

The polyamide and the multi-wall carbon nanotubes are mixed under heat (240° C.) with a DACA Micro Compounder blender for 15 minutes at 50 revolutions per minute. The plates obtained after pressing at 240° C. have a thickness of 0.6 mm and a diameter greater than 65 mm.

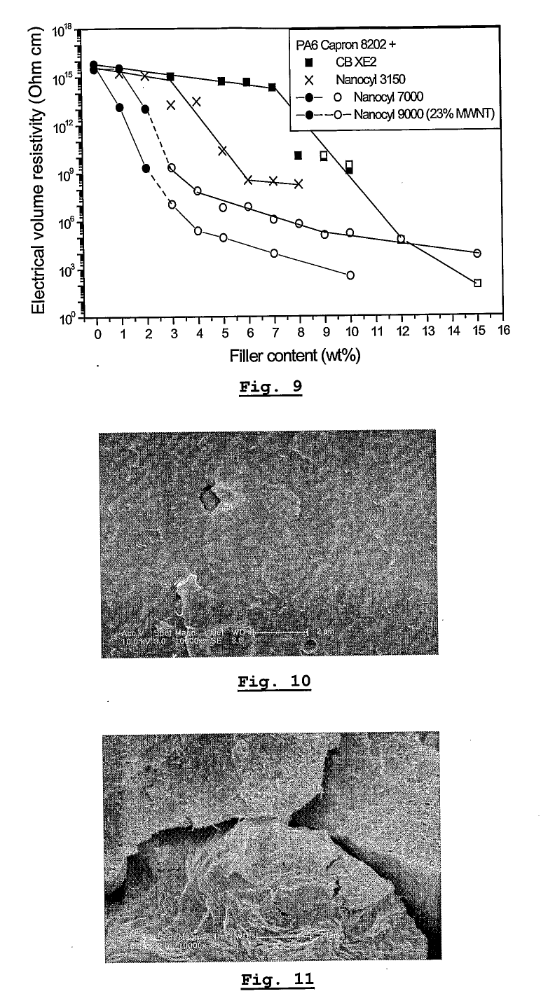

As shown in FIG. 9, the nanocomposite with a polyamide matrix, comprising coated carbon nanotubes dispersed by means of the method as in the invention and whose polyethylene coating is 78% by weight of the total weight of the coated nanotubes, has better electrical conductivity than composites comprising uncoated carbon nanotubes (N7000, which are MWNTs made of 90% carbon and N3150, which are MWNTs made of 95% carbon) or simply carbon black (Printex XE2). For the nanocomposite comprising the carbon nanotubes that have been dispersed by means of the method as in the invention, the percolation network occurs with 2% by weight of carbon nanotubes.

As shown in FIG. 10, a nanocomposite comprising a polyamide matrix and 1% by weight of MWNTs coated in polyethylene and dispersed by means of the method as in the invention has a fine and homogeneous dispersion of the carbon nanotubes in the polymer matrix on a nanoscopic scale. However, as shown in FIG. 11, for a nanocomposite comprising 5% by weight of MWNTs coated in polyethylene, the starting formation of a lamellar structure is observed, that may prove harmful to the achievement of the percolation network.

In a fourth embodiment example of the invention, the multi-wall carbon nanotubes (MWNTs) are coated in high-density polyethylene and dispersed by means of the method as in the invention in a PEEK matrix.

Table II shows the influence of the carbon nanotubes, dispersed by means of the method as in the invention or dispersed in the usual way, on the behaviour of the nanocomposite subjected to the tensile modulus test and to the bending modulus test.

TABLE II

| | Tensile modulus | Bending |
|---|---|---|
| | (MPa) | modulus (MPa) |
| PEEK | 3900 | 4250 |
| PEEK + 5% MWCNT | 4750 | 4700 |
| PEEK + 1.5% coated MWCNT | 4800 | 4950 |

As shown in this table, after the successive stages of extrusion, injection and casting, the nanocomposite with a PEEK matrix thus obtained and which comprises 1.5% by weight of coated multi-wall carbon nanotubes (Table II) has performances in the tensile modulus test that are comparable to those obtained by a nanocomposite with a PEEK matrix comprising 5% by weight of uncoated multi-wall nanotubes (Table II). This observation is equally valid with regard to the results obtained in the bending modulus test.

In the four above-described embodiment examples of the invention, the coating of the carbon nanotubes may be achieved by the method described in document WO 2005/012170.

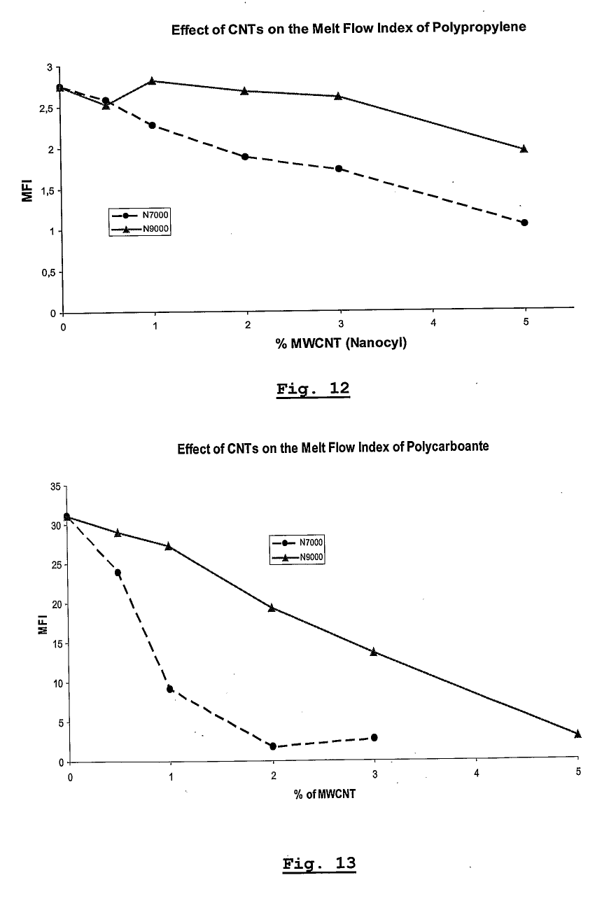

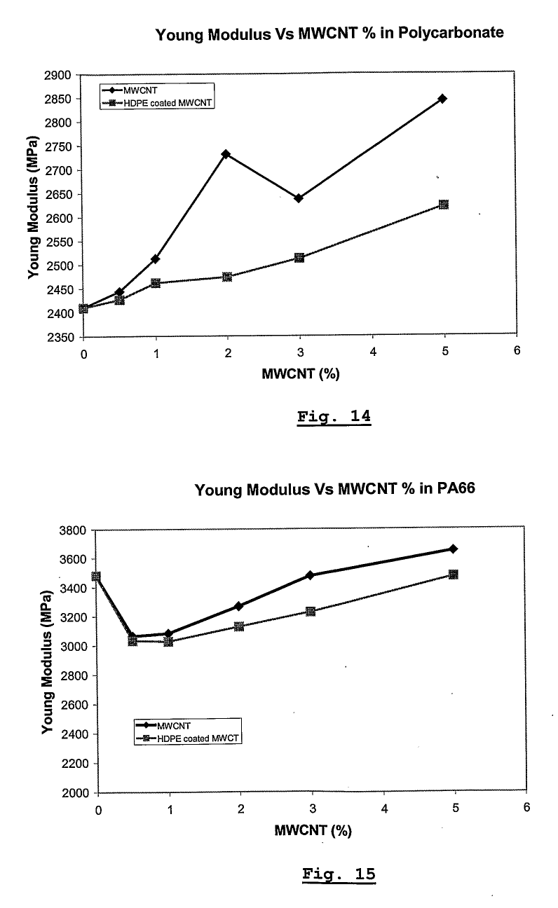

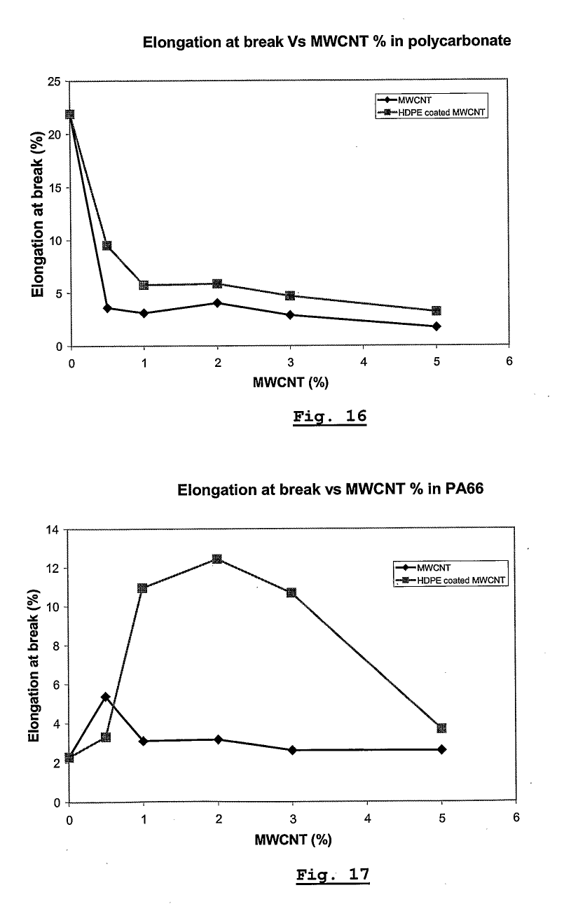

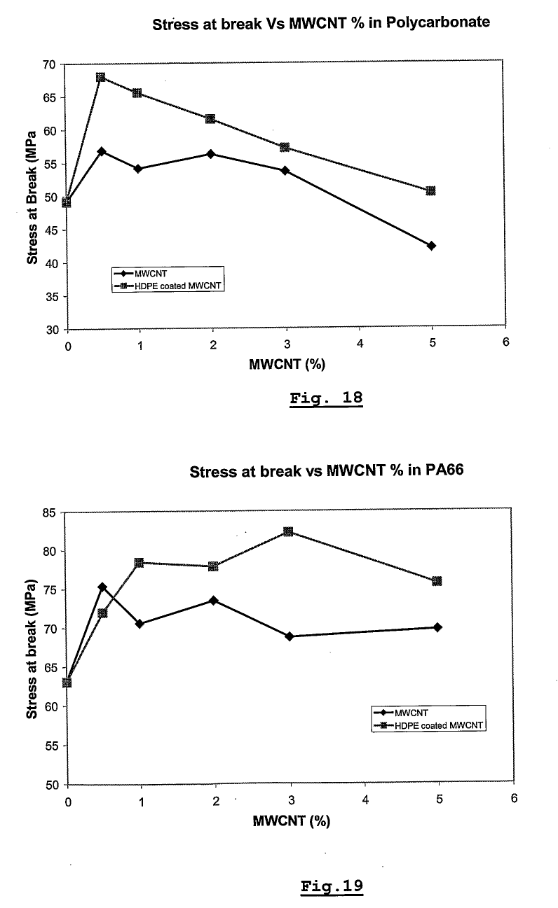

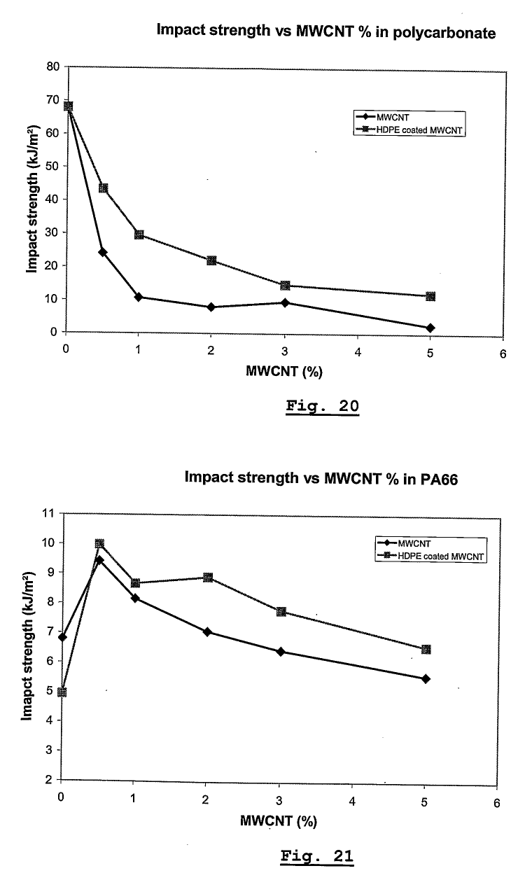

The dispersion of carbon nanotubes as in the invention achieves particular properties in polymer matrices into which they are incorporated. As shown in FIGS. 12 & 13, the method for dispersing the carbon nanotubes as in the invention affects the viscosity of a nanocomposite with a polypropylene or polycarbonate matrix but, for a nanocomposite with a polycarbonate or polyamide matrix, it also affects the elasticity properties, namely the tensile modulus (FIGS. 14 & 15), the deformation at break characteristics (FIGS. 16 & 17) and the resistance to breaking characteristics (FIGS. 18 & 19), as well as the properties of impact resistance (FIGS. 20 & 21).

1. Method for dispersing carbon nanotubes within a host polymer matrix on a nanoscopic scale comprising the following steps:
preparation of carbon nanotubes coated in a coating polymer by a polymerisation method of a monomer by means of a catalytic system in which said carbon nanotubes are used as catalytic supports, said carbon nanotubes comprising at their surfaces said catalytic system for the polymerisation of said coating polymer, said coating polymer being non-miscible with said host polymer matrix,
mixing of said coated carbon nanotubes with said non-miscible host polymer matrix, said coating polymer acting as a transporter for the carbon nanotubes in said host polymer matrix.

2. Dispersion method as in claim 1, wherein the non-miscible compatible polymer matrix is a polymer forming two phases with said coating polymer during mixing and having a free energy of the mixture (ΔGₘᵢₓ) greater than zero.

3. Dispersion method as in claim 1 wherein the non-miscible compatible host polymer matrix is selected from the group consisting of polypropylene, ethylene vinyl acetate (EVA) copolymer, alpha-olefin copolymers and mixtures thereof.

4. Dispersion method as in claim 1 wherein the host polymer matrix is a non-miscible incompatible polymer, forming two phases with said coating polymer and having a different chemical structure to that of said coating polymer, the mixture of said coating polymer and of the host polymer matrix having a Flory-Huggins parameter χ (chi) greater than zero and a high interface tension.

5. Dispersion method as in claim 1 wherein the non-miscible incompatible host polymer matrix is selected from the group consisting of polyamide (PA), polycarbonate (PC), polyether ether ketone (PEEK), polyether ketone (PEK), polystyrene, polyoxymethylene (POM), polyethyleneimine (PEI), polysulphone (PSU), polyacetale, polyetherimide, polyimide, polysulfene, polyacrylonitrile, poly-phenylsulfide, polyphenyl oxyde, polyurethane, polytetrafluoroethylene, polyester, poly-vinylidene fluoride, polyvinylchloride, polyethersulfide, poly perfluoroaldoxyethylene and mixtures thereof.

6. Dispersion method as in claim 1 wherein the coating polymer is selected from the group consisting of polyethylene, polypropylene, copolymers with alpha-olefins, conjugated alpha-diolefin polymers, polystyrene, polycycloalkenes, polynorbomene, polynorbor-nadiene, polycyclopendadiene and mixtures thereof.

7. Dispersion method as in claim 6 wherein the coating polymer is an alpha-olefin polymer.

8. Dispersion method as in claim 7 wherein the coating polymer is polyethylene.

9. Dispersion method as in claim 1 wherein the polymer for coating the carbon nanotubes is between 10 and 90% by weight of the total weight of the coated nanotubes.

10. Dispersion method as in claim 1 wherein the quantity of carbon nanotubes is between 0.1 and 5% by weight of the total weight of the host polymer matrix.

11. Dispersion method as in claim 10 wherein the quantity of carbon nanotubes is between 0.1 and 1% by weight of the total weight of the host polymer matrix.

12. Dispersion method as in claim 1 wherein the carbon nanotubes are multi-wall carbon nanotubes (MWNTs).

13. Use of a polymer for coating non-miscible carbon nanotubes compatible or incompatible with a host polymer matrix in order to obtain a homogeneous dispersion of said carbon nanotubes within a host polymer matrix on a nanoscopic scale.
